(19) United States
(12) Patent Application Publication
(10) Pub. No.: US 2011/0218321 A1
(43) Pub. Date: Sep. 8, 2011

(54) PROCESSES FOR PRODUCING POLYALKYLENE CARBONATES

(75) Inventors: Tobias Heinz Steinke, Speyer (DE); Anna Katharina Ott, Mannheim (DE); Hans-Helmut Görtz, Freinsheim (DE)

(73) Assignee: BASF SE, Ludwigshafen (DE)

(21) Appl. No.: 13/041,814

(22) Filed: Mar. 7, 2011

Related U.S. Application Data
(60) Provisional application No. 61/310,721, filed on Mar. 5, 2010.

(51) Int. Cl. C08G 59/68

(52) U.S. Cl. 528/414

(57) ABSTRACT

Production of polyalkylene carbonates via polymerization of carbon dioxide with at least one epoxide of the general formula (I):

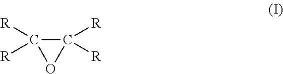

where R re mutually independently H, halogen, NO₂, CN, COOR′ or C₁₋₂₀-hydrocarbon moiety, which can have substitution, where one of the moieties R can also be OH, and where two moieties R can together form a C₃₋₅-alkylene moiety, R′ is H or C₁₋₂₀-hydrocarbon moiety, which can have substitution; n a zinc salt of C₄₋₈-alkanedicarboxylic acids as catalysts, where a carboxylic acid or an acidic ion exchanger and a non-water-miscible organic solvent which dissolves the polyalkylene carbonate are admixed with the reaction mixture obtained after the reaction, and the organic phase is washed with water, and the polyalkylene carbonate is optionally obtained from the organic phase.

### CROSS-REFERENCE TO RELATED APPLICATIONS

This application claims benefit under 35 U.S.C. §119(e) of U.S. Provisional Application 61/310,721, filed Mar. 5, 2010.

### BACKGROUND OF THE INVENTION

Polyalkylene carbonates, such as polypropylene carbonate, are obtained via alternating copolymerization of carbon dioxide and alkylene oxide, such as propylene oxide. A very wide variety of homogeneous, and also heterogeneous, catalysts are used for this purpose. The heterogeneous catalysts used especially comprise zinc glutarates.

WO 03/029325 describes processes for producing aliphatic polycarbonates. Compounds that can also be used here, alongside multimetal cyanide compounds, are zinc carboxylates, in particular zinc glutarate or zinc adipate. After production of the aliphatic polycarbonates, the resultant reaction mixture is poured into methanol which has been acidified with concentrated hydrochloric acid. A polymer precipitates and is filtered off and dried overnight.

Commercially available polypropylene carbonates (PPCs) produced with zinc catalysis are unpurified products. The materials have a milky haze and still comprise large amounts of zinc from the catalyst, for example from 0.3 to 1.2 g of Zn/100 g of polymer.

When hydrochloric acid is used in the work-up of the reaction products, acid-catalyzed depolymerization can occur, and this can be undesired. Furthermore, use of hydrochloric acid introduces traces of chlorine into the resultant polyalkylene carbonate.

### BRIEF SUMMARY OF THE INVENTION

The invention relates to a process for producing polyalkylene carbonates with improved purification of the polyalkylene carbonates, and also to a purification process, and to the use of monomeric or polymeric carboxylic acids or of acidic ion exchangers in the purification of polyalkylene carbonates.

It is an object of the present invention to provide an improved process for producing polypropylene carbonates in the presence of zinc salts of C₄₋₈-alkanedicarboxylic acids as catalysts, where the resultant reaction mixture is worked up in a simple manner and can be freed from catalyst residues. The preferred intention is that no depolymerization occurs, and the polyalkylene carbonate is to be obtainable with high purity.

The invention achieves the object via a process for producing polyalkylene carbonates via polymerization of carbon dioxide with at least one epoxide of the general formula (I):

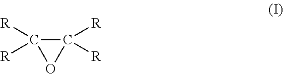

where R are mutually independently H, halogen, NO₂, CN, COOR′ or C₁₋₂₀-hydrocarbon moiety, which can have substitution, where one of the moieties R can also be OH, and where two moieties R can together form a C₃₋₅-alkylene moiety, R′ is H or C₁₋₂₀-hydrocarbon moiety, which can have substitution; on a zinc salt of C₄₋₈-alkanedicarboxylic acids as catalysts, where a carboxylic acid or an acidic ion exchanger and a non-water-miscible organic solvent which dissolves the polyalkylene carbonate are admixed with the reaction mixture obtained after the reaction, and the organic phase is washed with water, and the polyalkylene carbonate is optionally obtained from the organic phase.

One R in formula (I) can by way of example be a —CH₂—OH or —CH₂—O—C(═O)R′ moiety. The C₃₋₅-alkylene moiety is preferably a linear, terminal alkylene moiety.

The object is also achieved via a process for purifying polyalkylene carbonates comprising one or more zinc salts of C₄₋₈-alkanedicarboxylic acids, by carrying out the above purification step(s).

It has been found in the invention that use of monomeric or polymeric carboxylic acids or of acidic ion exchangers instead of hydrochloric acid markedly simplifies the work-up of the polyalkylene carbonates and can substantially inhibit depolymerization.

### DETAILED DESCRIPTION OF THE INVENTION

This invention can use any desired suitable carboxylic acids or acidic ion exchangers. The carboxylic acids can be mono- or polycarboxylic acids. They can be low-molecular-weight or polymeric carboxylic acids. The (poly)carboxylic acids or acidic ion exchangers can be used in (partially) neutralized form. Partially neutralized polyacrylates are obtainable by way of example from BASF SE as Sokolan®.

The carboxylic acids or acidic ion exchangers are used here during the purification of the polyalkylene carbonates, in particular in order to remove the polymerization catalysts. Polymerization catalysts used comprise zinc salts of C₄₋₈-alkanedicarboxylic acids, preferably zinc glutarate or zinc adipate, in particular zinc glutarate. Production and use of said catalysts are described by way of example in WO 03/029325.

The total number of carboxy groups and hydroxy groups in the carboxylic acids used in the invention is preferably at least 2, particularly preferably at least 3, in particular at least 4. By way of example, the number can be from 2 to 7, preferably from 3 to 6, in particular from 3 to 4.

The structure of the carboxylic acid preferably comprises at least one hydroxy group or at least one nitrogen atom.

The carboxylic acid preferably has at least four carbon atoms.

The carboxylic acids used in the invention can therefore have, for example, from 2 to 10 carbon atoms, preferably from 4 to 10 carbon atoms.

In one embodiment of the invention, the carboxylic acids have at least two carboxy groups and at least one hydroxy group, or, instead of the hydroxy group, at least one nitrogen atom.

These are preferably di- or tricarboxylic acids which also have hydroxy-functionalization.

Monocarboxylic acids that can be used, alongside acetic acid and gluconic acid, are in particular citric acid, tartaric acid, maleic acid, ascorbic acid, and complexing agents, such as ethylenediaminetetraacetic acid (EDTA) and methylglycinediacetic acid, e.g. as trisodium salt (e.g. Trilon®M from BASF SE).

In particular, the use of the di- and tricarboxylic acids, where these also have hydroxy-functionalization, also leads to the following advantages in comparison with the use of acetic acid.

When comparison is made with acetic acid, it is possible to use less acid to remove a certain amount of catalyst (from 5 to 30% by weight instead of about 40% by weight, based on the amount of catalyst).

Use of equivalent amounts of polyfunctional carboxylic acids gives better removal effect.

It is possible to use acids which are non-hazardous in foods and in some cases indeed are used as food additives, e.g. citric acid, ascorbic acid, tartaric acid.

The number of washing steps required to clarify the product can be reduced, e.g. down to one washing step.

The use of the hydroxycarboxylic acids leads to less potential hazard, since these acids are merely irritant rather than, like acetic acid, corrosive.

The extent of molecular-weight degradation observed to result from the hydroxy-functionalized di- and tricarboxylic acids is smaller in comparison with acetic acid and hydrochloric acid.

It is also possible to use polycarboxylic acids, such as polyacrylic acids, for example those marketed by BASF SE as Sokalan®.

The invention can moreover also use acidic ion exchangers. These can be ion exchangers having carboxy groups or sulfonyl groups or sulfoxy groups. Ion exchangers derived from polystyrene substrates have often been acid-derivatized via reaction with concentrated sulfuric acid.

Examples of suitable ion exchangers are obtainable as Dowex®, for example high-acidity Dowex50WX8-200 from Dow. The invention can also use other similar ion exchangers.

The ion exchangers most commonly used nowadays are polystyrene resins which have been crosslinked with divinylbenzene (DVB) and thus exhibit a high level of high-molecular-weight, three-dimensional structure, mostly taking the form of beads.

Sulfonation of the crosslinked polystyrene resin, for example with oleum, produces a high-acidity cation exchanger. An alternative to the reaction with sulfuric acid is the reaction with perfluorosulfonic acid, cf. Applied Catalysis A: General 221 (2001), pages 45 to 62. To produce low-acidity cation exchangers, acrylic acid derivatives, instead of styrene, are crosslinked with divinylbenzene. The free carboxy groups of the polyacrylates can be obtained via basic hydrolysis of the ester groups. Phenol-formaldehyde gels can moreover also be used.

The amount of carboxylic acid is preferably from 5 to 80% by weight, particularly preferably from 7.5 to 40% by weight, in particular from 10 to 25% by weight, based on the polyalkylene carbonate.

The carboxylic acid here can be used in the form of liquid or solid, or in dissolved form.

A non-water-miscible, organic solvent which dissolves the polyalkylene carbonate is admixed with the reaction mixture obtained after the reaction. Esters provide an example of a suitable solvent that can be used, preference being given to C₁₋₁₂-alkyl esters of C₁₋₁₂-alkanecarboxylic acids. It is particularly preferable to use ethyl acetate as solvent.

The amount of solvent added is preferably from 10 to 1000%, particularly preferably from 50 to 500%, in particular from 70 to 140%, based on the amount of reaction mixture (polymer solution) after the polymerization reaction. The amount can be adjusted to depend on the solids content of the polymer solution or of the reaction mixture. The amount of ethyl acetate admixed is typically the same as that of the polymer solution (based on volume). If the solids content of the polymer solution is below 18% by weight, the amount of ethyl acetate can be reduced somewhat.

The reaction with the carboxylic acid or with the acidic ion exchanger preferably involves motion of the mixture made of reaction mixture and of organic solvent. To this end, suitable mixing apparatuses can be used, examples being conventional mixer units.

The reaction with the carboxylic acid or with the acidic ion exchanger is preferably carried out for a period in the range from 5 minutes to 5 days, particularly preferably from 15 minutes to 5 hours.

The temperature at which this reaction takes place with the carboxylic acid is preferably from 10 to 60° C. In particular, the reaction takes place at room temperature (22° C.).

It can be useful, depending on carboxylic acid used, to react the polyalkylene carbonate with a carboxylic anhydride prior to admixture of the carboxylic acid or of the acidic ion exchanger. The carboxylic anhydride used can comprise any desired suitable carboxylic anhydrides, the anhydrides of the monocarboxylic acids and anhydrides of the dicarboxylic acids. Examples are maleic anhydride and acetic anhydride. It is particularly preferable to use acetic anhydride.

The amount of carboxylic anhydride here is preferably from 0.5 to 25% by weight, particularly preferably from 1 to 15% by weight, in particular from 2 to 10% by weight, based on the polyalkylene carbonate.

The temperature at which the reaction with the carboxylic anhydride takes place is preferably in the range from 10 to 60° C. In particular, reaction takes place at room temperature (22° C.). The addition preferably takes place prior to addition of the acid.

The reaction with carboxylic anhydride, in particular acetic anhydride, protects the chain ends of the polyalkylene carbonate. This inhibits any possible molecular-weight degradation due to anionic attack, for example by the acetate from the acetic acid.

When the preferred polyfunctional carboxylic acids are used, in particular di- and tricarboxylic acids, where these also have hydroxy-functionalization, there is generally no significant or pronounced molecular-weight degradation of the polyalkylene carbonates. When they are used it is therefore possible to omit the protection of the chain ends by carboxylic anhydride, in particular acetic anhydride. When citric acid is used as carboxylic acid, there is by way of example no need for protection of the chain ends by carboxylic anhydride, such as acetic anhydride. The result is simplification of the purification process to the extent of one component, and it is possible to omit one addition step (for the anhydride).

Once the reaction mixture has been reacted with the carboxylic acid or with the acidic ion exchanger, it is washed with water. To this end, the reaction mixture is intimately mixed with water, and the aqueous phase is removed after subsequent phase separation. The amount of water added per wash is preferably from 0.01 to 5 times, particularly preferably from 0.5 to 2 times, the amount (weight) of the reaction mixture with non-water-miscible, organic solvent. It is also possible that the acid solution already comprises the water.

One or more wash steps can be carried out in succession in the invention. It is preferable to carry out a sufficient number of wash steps to reach a final pH of about 4 or higher of the organic phase.

The time for phase separation into organic phase and aqueous phase can vary, depending on the carboxylic acid used. The number of wash steps required can also depend on the nature of the carboxylic acid used, as described in the examples below.

Once the organic phase has been washed with water and the aqueous phase has been removed, the polyalkylene carbonate can be obtained from the organic phase. By way of example, this can be achieved via evaporation of the organic solvent. To the extent that the polyalkylene carbonate is to be further processed in solution, it can also remain within the organic phase.

The process for producing polyalkylene carbonates via polymerization of carbon dioxide with at least one epoxide of the general formula (I) is described in general terms in WO 03/029325. The production of the zinc glutarate catalyst described in that document, via reaction of zinc oxide with glutaric acid, can also be carried out in the invention. The zinc glutarate catalysts described in WO 03/029325 can also be used in the invention.

In the production of the catalysts, the zinc oxide particles are preferably reacted with terminal C₄₋₈-alkanedicarboxylic acids. The reaction is preferably carried out with glutaric acid, adipic acid, or a mixture thereof. The zinc salts here are preferably therefore zinc glutarates or zinc adipates.

The polymerization reaction preferably uses the catalyst in anhydrous form. For the purposes of the invention, anhydrous means that the water content within the catalyst is preferably less than 1% by weight, particularly preferably at most 10 ppm, based on the entire catalyst. Anhydrous particularly preferably means that the catalyst comprises no water or only insignificant traces of water—other than chemically bound water (for example water of crystallization), and in particular no water adhering to the surface or physically included in cavities.

As epoxide, it is preferable to use ethylene oxide, propylene oxide, butene oxide, cyclopentene oxide, cyclohexene oxide, isobutene oxide, acrylic oxides, or a mixture thereof. It is particularly preferable to use propylene oxide, cyclohexene oxide, ethylene oxide, or a mixture thereof. In particular, propylene oxide is used.

Reference can be made to WO 03/029325, pages 6 and 7 for other possible epoxides. Use of CO₂ and of two or more epoxides produces polycarbonate terpolymers. Examples of mixtures of two epoxides that can be used are ethylene oxide and propylene oxide, ethylene oxide and cyclohexene oxide, propylene oxide and cyclohexene oxide, isobutene oxide and ethylene oxide or propylene oxide, butylene oxide and ethylene oxide or propylene oxide.

The quantitative proportion of carbon dioxide with respect to epoxide can be varied widely. It is usual to use an excess of carbon dioxide, i.e. more than 1 mol of carbon dioxide per mole of epoxide.

The process of the invention preferably consists essentially of the following steps:
1. drying of the catalyst or rendering the catalyst anhydrous,
2. using the anhydrous catalyst as initial charge in a polymerization reactor,
3. optional addition of an inert reaction medium,
4. addition of carbon dioxide,
5. addition of the epoxide,
6. heating of the reactor to the reaction temperature,
7. optional addition of further carbon dioxide, and
8. once the polymerization reaction has been completed, work-up of the reactor content to give the polycarbonate, where steps 5 and 6 can be interchanged.

The reaction can be carried out in an inert reaction medium in which the catalyst can be dissolved or dispersed.

Substances suitable as inert reaction medium are all of those which do not adversely affect the activity of the catalyst, in particular aromatic hydrocarbons, such as toluene, xylene, benzene, and also aliphatic hydrocarbons, such as hexane, cyclohexane, and halogenated hydrocarbons, such as dichloromethane, chloroform and isobutyl chloride. Ethers, such as diethyl ether, are also suitable, as also are tetrahydrofuran, diethylene glycol dimethyl ether (diglyme), dioxane, and nitro compounds, such as nitromethane. It is preferable to use toluene.

The inert medium can by way of example be injected undiluted into the polymerization reactor, or can preferably be injected with a gas stream, and the gas used here can comprise an inert gas, such as nitrogen, or else the reactant CO₂.

It is preferable to begin by using the catalyst as initial charge in the reactor, and to render the same anhydrous by heating in the stream of inert gas, and optionally to cool the same, and to use gas to inject the inert reaction medium into the reactor, with stirring.

The concentration of the catalyst is preferably from 0.01 to 20% by weight, in particular form 0.1 to 10% by weight, based on the catalyst solution or catalyst dispersion (entirety of catalyst and reaction medium).

The concentration of the catalyst, based on the entirety of epoxide and inert reaction medium, is preferably from 0.01 to 10% by weight, particularly preferably from 0.1 to 1% by weight.

In another embodiment, likewise preferred, operations are carried out without inert reaction medium.

The invention begins by bringing the catalyst into contact with at least a portion of the CO₂, before epoxide is added.

The meaning of “with at least a portion” here is that prior to addition of the epoxide either a portion of the entire amount of CO₂ used is added or the entire amount of CO₂ is added at this stage.

It is preferable to add only a portion of the CO₂ and it is particularly preferable that this portion is from 20 to 80% by weight, in particular from 55 to 65% by weight, of the total amount of the CO₂.

The CO₂ is usually added as gas, and the amount of CO₂ is adjusted to depend on the temperature, by way of the pressure of the CO₂ gas. Given room temperature (23° C.) in the reactor, the CO₂ pressure prior to addition of the epoxide (hereinafter termed CO₂ admission pressure), where this corresponds to the preferred portion of CO₂, is from 5 to 70 bar, in particular from 10 to 30 bar when the zinc carboxylate catalysts are used, and from 5 to 70 bar, in particular from 10 to 50 bar when the multimetal cyanide catalysts are used. Typical values for the CO₂ admission pressure are 15 bar for zinc carboxylate catalysts and 50 bar for multimetal cyanide catalysts, in each case at 23° C.

All pressures stated are absolute pressures. Adjustment of the CO₂ admission pressure can be achieved discontinuously in a single step or can be divided into a plurality of steps, or else can be achieved continuously over a particular period linearly or in compliance with a linear, exponential or staged gradient.

When the CO₂ admission pressure is selected, attention has to be paid to the pressure rise in the reactor due to the subsequent heating of the reactor to the reactor temperature. The CO₂ admission pressure (e.g. at 23° C.) has to be selected in such a way that the desired final CO₂ pressure is not exceeded at reaction temperature (e.g. 80° C.).

The catalyst is generally brought into contact with CO₂ at temperatures of from 20 to 80° C., preferably from 20 to 40° C. It is particularly preferable to operate at room temperature (23° C.). The period over which catalyst and CO₂ are brought into contact depends on the volume of the reactor and is usually from 30 sec to 120 min.

The catalyst, or the solution or dispersion of the catalyst in the inert reaction medium, is generally stirred during while it is brought into contact with the CO₂.

The epoxide is added to the reactor only after the catalyst has been brought into contact with CO₂. The epoxide is usually injected undiluted into the reactor, or preferably with a small amount of inert gas or CO₂.

The epoxide is usually added with stirring, and can be added all at once (in particular in the case of small reactor volume) or continuously over a period which is generally from 1 to 100 min, preferably from 10 to 40 min, and the addition rate here can be constant over time or can comply with a gradient which can by way of example rise or fall or be linear, expotential, or stepped.

The temperature during the addition of the epoxide is generally from 20 to 100° C., preferably from 20 to 70° C. In particular, it is possible a) either to add the epoxide at low temperature (e.g. room temperature 23° C.) and then adjust the reactor to the reaction temperature T_{R} (e.g. 80° C.) or b) conversely to begin by adjusting the reactor to the reaction temperature T_{R} and then add the epoxide. Variant a) is preferred.

Accordingly, the reactor is brought to the reaction temperature T_{R} prior to or—preferably—after addition of the epoxide. The reaction temperature is usually adjusted to from 30 to 180° C., in particular from 50 to 130° C. This is usually achieved via heating of the reactor with stirring. The reaction temperature is usually from 40 to 120° C., preferably from 60 to 90° C.

Once the reaction temperature has been reached, the remaining amount of the CO₂ is added, preferably with stirring, to the reactor, insofar as the entire amount of CO₂ has not already been introduced (see above) during the period when the catalyst is brought into contact with CO₂. The amount of CO₂ is in turn usually adjusted by way of the pressure of CO₂ gas.

It is preferable that CO₂ is added until the CO₂ pressure (hereinafter termed final CO₂ pressure) is from 1 to 200 bar, preferably from 10 to 100 bar when zinc carboxylate catalysts are used, and from 20 to 200 bar, preferably from 80 to 100 bar when multimetal cyanide catalysts are used. Typical values for the final CO₂ pressure are from 20 to 100 bar for zinc carboxylate and 100 bar for multimetal cyanide catalysts.

All of the pressures stated are absolute pressures. The amount of CO₂ added in this step (final CO₂ pressure) naturally also depends on the portion of CO₂ already added in advance.

From the CO₂ pressures and reaction temperatures mentioned it is apparent that the CO₂ in the reactor can be in the supercritical state (i.e. liquid). In particular in the case of final CO₂ pressures above 74 bar and reaction temperatures T_{R} above 31° C., the CO₂ is in the supercritical state. However, the present process differs from conventional chemical reactions in critical CO₂ in that the CO₂ is not merely reaction medium but simultaneously starting material (reactant) and reaction medium.

The final CO₂ pressure can be adjusted discontinuously in one step or continuously, as described for the CO₂ admission pressure.

Once the final CO₂ pressure has been achieved, it can, if necessary, be maintained by adding further amounts corresponding to the CO₂ consumed. If no further amounts of CO₂ are added, the CO₂ pressure generally falls during the reaction because of consumption of CO₂. This procedure is likewise possible.

The time required to complete the polymerization reaction is usually from 60 to 500 min, preferably from 120 to 300 min. A typical value for said after-reaction time is from 3 to 4 hours.

The reaction temperature is usually held constant here; however, it can also be raised or lowered, depending on the progress of the reaction.

The quantitative proportions of CO₂:epoxide used in the process depend in a known manner on the desired properties of the polymer. The quantitative proportion (ratio by weight) total amount of CO₂:total amount of epoxide is usually from 1:1 to 2:1.

In one preferred embodiment, all of the abovementioned steps are undertaken with exclusion of water: it is not only the catalyst that is anhydrous or is rendered anhydrous in the conventional manner, but also the inert reaction medium, the CO₂, and also the epoxide.

Once the polymerization reaction has been completed, the reactor contents are worked up to give the polycarbonate. A general procedure is to allow the reactor to cool, with stirring, equalize pressure with the environment (aerate the reactor), and discharge the reaction mixture comprising polycarbonate polymer. It is possible here, if desired, to add the contents of the reactor to a suitable precipitant.

The precipitant usually used comprises alcohols, such as methanol, ethanol, propanol, or ketones, such as acetone. Methanol is preferred. It is advantageous to acidify the precipitant to pH from 0 to 5.5.

The precipitated polymer can be isolated in the conventional manner, e.g. via filtration, and dried in vacuo.

In some instances, a portion of the polycarbonate reaction product is also in dissolved or dispersed form in the precipitant, for example in acidified methanol. This polycarbonate can be isolated in the conventional manner via removal of the precipitant. By way of example, the methanol can be removed by distillation at reduced pressure, for example on a rotary evaporator.

However, it is preferable that the non-water-miscible, organic solvent and the carboxylic acid or the ion exchanger are admixed directly with the reaction mixture, without prior precipitation. A previously precipitated polymer can also be redissolved subsequently in the non-water-miscible, organic solvent.

The polyalkylene carbonates obtained in the invention can be further processed in many different ways to give moldings, foils, films, coatings, and sheets, in which connection see by way of example WO 03/029325, pages 21 and 22.

The invention will now be described in further detail with reference to the following non-limiting examples.

### EXAMPLES

The polypropylene carbonate was produced by analogy with WO 2003/029325.

### 1. Catalyst Production

35 g of ground zinc oxide were used as initial charge in 250 ml of absolute toluene in a 1 l four-necked flask equipped with stirrer bar, heating bath, and a water separator. After addition of 53 g of glutaric acid, the mixture was heated for 2 hours to 55° C., with stirring. It was then heated to boiling point, whereupon the water of reaction was removed by azeotropic distillation at reflux until no more water passed over. The toluene was removed by distillation and the residue was dried at 80° C. in a high vacuum.

### 2. Polymerization

12 g of zinc glutarate were placed in the reactor as initial charge. A 3.5 l autoclave was used, with mechanical stirrer. Once the reactor had been sealed, it was flushed repeatedly with N₂ gas. 620 g of toluene were then added, and 6 bar of CO₂ were injected into the reactor at room temperature (23° C.). 310 g of propylene oxide were then injected into the reactor and heated to 80° C. CO₂ was then injected into the reactor at 80° C. until the CO₂ pressure reached was 40 bar. The reactor was kept at 80° C. for 4 h, without addition of any further CO₂. It was then allowed to cool to room temperature.

3.1 Work-Up with HCl (Comparison)

Work-up with HCl: work-up took place as in WO 03/029325 A1. The reactor was aerated, and the reactor contents were poured into 1 l of methanol which had been acidified with 5 ml of concentrated hydrochloric acid (37% by weight). A polymer precipitated and was filtered off and dried in vacuo at 60° C. overnight.

3.2 Work-Up with Acetic Acid (HAc)

The equivalent amount of ethyl acetate was admixed with the polymer solution from 2. If the solids content of the polymer solution should be below 18%, the amount of ethyl acetate was corrected downward to some extent. After subsequent stirring, 4% of acetic anhydride (amount based on amount of acetic acid) were added, and the mixture was again stirred. After addition of 40% of acetic acid, based on solids content, and stirring, water was used for dilution (amount of water corresponding to the amount of organic phase) and for washing. Phase separation could take from 1 h to 48 h, depending on the mixture. The said washing step was carried out from four to five times. The initial pH, i.e. after addition of the acid, was about 1. The pH was 4 after from four to five washes.

4. Work-Up with Polyfunctional Carboxylic Acids/Hydroxycarboxylic Acids

### 4.1 Citric Acid C₆H₈O₇

The equivalent amount of ethyl acetate was admixed with the polymer solution. If the solids content of the polymer solution should be below 18%, the amount of ethyl acetate was corrected downward to some extent. After subsequent stirring, 4% of acetic anhydride (amount based on amount of citric acid) were added, and the mixture was again stirred. The amount of citric acid that had to be added, in the form of a saturated solution (500 g of citric acid for 1 L of water) based on solids content, was only 20%. Here, the polymer solution became clear after only one wash.

The number of washes needed is therefore smaller than in the case of the acetic-acid wash. Another advantage is moreover apparent when citric acid is used: the initial pH here is itself from 2.5 to 3, and the number of washing steps needed to reach the final pH of 4 is therefore smaller. There are from 2 to 3 wash steps here, contrasting with from 4 to 5 wash steps in the case of the acetic acid variant.

When citric acid was used, the time for separation of the organic and the aqueous phase (max. 5 min) was markedly less than when HAc was used (from 15 to 30 min). Furthermore, when citric acid was used the organic phase was clear after only one wash. With HAc, this was achieved only after repeated washing.

Another advantage of citric acid over acetic acid is found in chemical properties: acetic acid is classified as corrosive (C) (R10-35, S(1/2)-23-26-45), whereas citric acid is only irritant (R36, S26). This also makes handling of the acid much more pleasant. The acids are used in excess, based on the amount of catalyst to be destroyed. It is therefore sometimes possible here that deprotenated acid which has not reacted with a catalyst particle attacks the chain ends of the polymers. This was observed in the case of hydrochloric acid and (dilute) acetic acid. The effect did not occur with the di- and tricarboxylic acids, where these also have hydroxy-functionalization. It is possible, because of the geometry of the acids, that the negative charge of the carboxylates is shielded via the proton of the adjacent hydroxy unit by virtue of hydrogen bonding. The carboxylates therefore become less aggressive with respect to the polymer chain ends, and molecular-weight degradation is thus reduced.

The reason for the optional addition of about 4% of acetic anhydride (AA) is as follows: the intention is to protect the chain ends of the PPC with acetic anhydride and thus inhibit molecular-weight degradation due to anionic attack, for example by the acetate from the acetic acid. If one compares experiments where 20% of citric acid and 4% of acetic anhydride were added at 40° C. and three washes were carried out with analogous experiments without acetic anhydride, no disadvantages arise from the absence of acetic anhydride when citric acid is used instead of acetic acid. When citric acid is used, there is therefore no need for any protection of the chain ends by acetic anhydride, and the work-up process is thus simplified to the extent of one component and one addition step. The quality of the washing process is retained, and the zinc values are about 20 ppm. The molar masses are Mn 100 000 g/mol and Mw 800 000 g/mol.

When the amount of citric acid is reduced to 10%, based on solids content of polymer, wash performance (40 ppm of zinc) at 40° C. and molar mass (Mn=99 700 g/mol, Mw=773 000 g/mol) also remain very good without addition of acetic anhydride. If the amount of citric acid is reduced to only 5%, molecular weight remains unaffected, but content of residual zinc does not fall below 200 ppm in three washes. If the reactions are carried out at room temperature with 5% and 10%, the separation of the organic and the aqueous phase from each other takes substantially longer (from 10 min to 30 min) than at 40° C., but the properties of the polymer are otherwise unaltered (Mₙ=124 000 g/mol), as also is the zinc content (150 ppm).

4.2 Tartaric Acid C₄H₆O₆ (2,3-dihydroxysuccinic Acid or 2,3-dihydroxybutanedioic Acid)

The experiments with tartaric acid were carried out by analogy with those using acetic acid and citric acid. Tartaric acid performs somewhat less well than citric acid in the quality of the wash processes, but likewise better than the conventional acetic acid. At room temperature it was necessary here, as in the case of acetic acid, to add 40%, based on solids content, but only three wash steps were needed instead of from 4 to 5. It was also possible in the case of tartaric acid to minimize the number of wash steps needed to from 1 to 2 if the temperature of the polymer solution, and also of the wash solution, was increased to 40° C. At an operating temperature of 40° C., the amount could be reduced from 40 to 20%. The concentration of residual zinc rose, however, from 0.023 g/100 g of polymer at room temperature and 40% of acid to 0.06 g/100 g of polymer at 40° C. and 20% of acid.

### 4.3 Gluconic Acid C₆H₁₂O₇

In the case of gluconic acid, the amounts that had to be used were similar to those known from acetic acid (about 40%). Separation performance was also similar. Zinc contents after three washes were from 2 to 40 mg of zinc per 100 g of polymer. However, the polymer was similarly glass-clear after only three separation processes. Even if the amount of acid that had to be used here was just as much as in the case of acetic acid, the number of washes needed was only 3 instead of from 4 to 5. The clear advantage of the use of gluconic acid is found in the molar mass of the polypropylene carbonate. This is always from 40 000 to 50 000 g/mol (MO and therefore markedly higher than the molar masses typically obtained in the case of work-up with acetic acid (Mₙ=from 25 000 to 40 000 g/mol).

### 4.4 Ethylenediaminetetraacetic Acid (EDTA) C₁₀H₁₆N₂O₈

When 40 mol % of Na EDTA were added to the polymer solution requiring washing (based on solids content) at room temperature the extent of removal of the zinc glutarate achieved with three washes was modest. The amount of zinc residues was about 1 g per 100 g of polymer. The polymer solution was also not clear. However, the highest molar masses for the PPC were found here, with Mₙ above 50 000 g/mol. pH also was about 7, and therefore within the ideal range, even after only three washes. This could not be achieved with the conventional processes or with the abovementioned acids.

### 4.5 Maleic Acid C₄H₆O₅

If 40% by weight of maleic acid, based on solids content (used in the form of aqueous solution: 500 g/L) were admixed with a PPC solution and the mixture was washed three times with water, a clear polymer solution was obtained. Separation performance was comparable with that of citric and tartaric acid. At 40° C., as would be expected, there as a slight improvement in the washing process in comparison with the process at room temperature.

### 5. Acidic Ion Exchanger (High-Acidity Dowex50WX8-200)

The ion exchanger was charged to a column with glass frit (pore width 1) and was wetted with ethyl acetate. A very dilute PPC solution (5% solids content) was then filtered over the ion exchanger.

Although the polymer solution had to be very dilute, filtration over the ion exchanger gave a clear polymer solution. The ion exchanger was capable of destroying and removing the zinc glutarate from PPC solutions. Furthermore, there is the option here of realizing a continuous process.

The tables below collate the results.

| PPC dispersion | | | | | AA | | | Analysis of | | |
|---|---|---|---|---|---|---|---|---|---|---|
| used | | Solvent addition | Acid for | | Based | | Appearance of | dispersion after acid | | |
| GPC | GPC | Based on amount | degradation | | on | Temper- | dispersion after | | GPC | |
| Mn | Mw | of polymer solution | Type | Amount | acid | ature | Acid treatment | Zinc | Mn | GPC Mw |
| 28 000 | 440 000 | 50 wt % EA | Acetic | 20 wt % | | 40° C. | opaque after | | | |
| | | | acid | based on | | | drying | | | |
| | | | | SC | | | | | | |
| ″ | ″ | 75 wt % EA | ″ | 40 wt % | | 40° C. | clear | 5 mg/100 g | 31 000 | 660 000 |
| | | | | based on | | | | | | |
| | | | | SC | | | | | | |
| ″ | ″ | 75 wt % EA | ″ | 40 wt % | 20% | 40° C. | clear | 73 mg/100 g | 46 000 | 750 000 |
| | | | | based on | | | | | | |
| | | | | SC | | | | | | |
| 35 000 | 510 000 | 75 wt % EA | ″ | 40 wt % | 2% | 40° C. | clear | 0.1 g/100 g | | |
| | | | | based on | | | | | | |
| | | | | SC | | | | | | |
| ″ | ″ | 75 wt % EA | ″ | 40 wt % | 2% | 40° C. | clear | 3 mg/100 g | | |
| | | | | based on | | | | | | |
| | | | | SC | | | | | | |
| 34 000 | 420 000 | 100 wt % EA | ″ | 33 wt % | 2% | 40° C. | clear | 3 mg/100 g | 91 000 | 680 000 |
| | | | | based on | | | | | | |
| | | | | SC | | | | | | |
| ″ | ″ | 100 wt % EA | ″ | 50 wt % | 2% | 40° C. | clear | 12 mg/100 g | 68 000 | 660 000 |
| | | | | based on | | | | | | |
| | | | | SC | | | | | | |
| ″ | ″ | 100 wt % EA | none | | 110 | | glass-clear | 0.1 g/100 g | 62 000 | 739 000 |
| | | | | | mol % | | | | | |
| | | | | | based | | | | | |
| | | | | | on SC | | | | | |
| 49 000 | 560 000 | 100 wt % EA | Acetic | 40 wt % | 4% | 40° C. | clear | 0.01 g/100 g | 77 500 | 839 000 |
| | | | acid | based on | | | | | | |
| | | | | SC | | | | | | |
| 62 000 | 739 000 | 100 wt % EA | Acetic | 40 wt % | 4% | 40° C. | clear | | 41 400 | 527 000 |
| | | | acid | based on | | | | | | |
| | | | | SC | | | | | | |
| not measured | | 20 wt % EA | ″ | 40 wt % | 4% | RT | very free-flowing, | 0.062 g/ | 105 000 | 789 000 |
| | | 80 wt % of butyl | | based on | | | clear | 100 g | | |
| | | acetate | | SC | | | | | | |
| ″ | ″ | 20 wt % EA | ″ | 40 wt % | 4% | RT | free flowing, glass- | 0.003 g/ | 100 000 | 789 000 |
| | | 80 wt % of butyl | | based on | | | clear | 100 g | | |
| | | acetate | | SC | | | | | | |
| | | 20 wt % EA | ″ | 40 wt % | 4% | RT | Poor separation, | 0.081 g/ | 132 000 | 621 000 |
| | | 80 wt % Isopentyl | | based on | | | cloudy to white | 100 g | | |
| | | acetate | | SC | | | | | | |
| ″ | ″ | 100 wt % EA | ″ | 40 wt % | 4% | RT | Organic phase to water | 0.009 g/ | 90 000 | 891 000 |
| | | | | based on | | | 1:3; very good | 100 g | | |
| | | | | SC | | | separation; org. phase | | | |
| | | | | | | | clear | | | |
| ″ | ″ | 100 wt % EA | Oleic | 40 wt % | 4% | RT | Relatively good | | 1720 | 609 000 |
| | | | acid | based on | | | separation, streaking | | | |
| | | | | SC | | | org. phase opaque | | | |
| | | 100 wt % EA | Citric | 40 wt % | 4% | RT | Very rapid | | 101 000 | 1 020 000 |
| | | | acid | based on | | | clarification, good | | | |
| | | | | SC | | | separation | | | |
| | | | | | | | org. phase very clear | | | |
| 77 000 | 778 000 | 100 wt % EA | Citric | 40 wt % | 4% | RT | Very good separation | <0.001 g/ | 64 200 | 594 000 |
| | | | acid | based on | | | org. phase very clear | 100 g | | |
| | | | | SC | | | | | | |
| ″ | ″ | 100 wt % EA | Citric | 80 wt % | none | RT | Very good separation | <0.001 g/ | 65 300 | 587 000 |
| | | | acid | based on | | | org. phase very clear | 100 g | | |
| | | | | SC | | | | | | |
| ″ | ″ | 100 wt % EA | Citric | 40 wt % | 4% | RT | Rapidly very clear, | <0.001 g/ | 63 700 | 598 000 |
| | | | acid | based on | | | good separation | 100 g | | |
| | | | | SC | | | | | | |
| ″ | ″ | 200 wt % EA | Citric | 40 wt % | 4% | RT | Rapidly very clear, | <0.001 g/ | 81 000 | 782 000 |
| | | | acid | based on | | | good separation | 100 g | | |
| | | | | SC | | | | | | |
| ″ | ″ | 100 wt % EA | Citric | 20 wt % | 4% | RT | Initially slightly | 0.017 g/ | 83 500 | 843 000 |
| | | | acid | based on | | | opaque, | 100 g | | |
| | | | | SC | | | subsequently clear | | | |
| | | | | | | | Good separation | | | |
| not measured | | 100 wt % EA | Citric | 20 wt % | 4% | 40° C. | Very clear, good | 0.025 g/ | 98 100 | 747 000 |
| | | | acid | based on | | | separation | 100 g | | |
| | | | | SC | | | inclusion of water | | | |
| | | | | | | | bubbles | | | |
| ″ | ″ | 100 wt % EA | Citric | 20 wt % | none | 40° C. | Very rapidly very clear | 0.002 g/ | 108 000 | 806 000 |
| | | | acid | based on | | | | 100 g | | |
| | | | | SC | | | | | | |
| ″ | ″ | 100 wt % EA | Citric | 10 wt % | none | 40° C. | Clear within a few min. | 0.004 g/ | 99 700 | 773 000 |
| | | | acid | based on | | | | 100 g | | |
| | | | | SC | | | | | | |
| ″ | ″ | 100 wt % EA | Citric | 5 wt % | none | 40° C. | Org. Phase clear | 0.024 g/ | 106 000 | 812 000 |
| | | | acid | based on | | | | 100 g | | |
| | | | | SC | | | | | | |
| ″ | ″ | 100 wt % EA | Citric | 10 wt % | 4% | RT | About 30 min. required | 0.015 g/ | 124 000 | 857 000 |
| | | | acid | based on | | | for clarification | 100 g | | |
| | | | | SC | | | then clear | | | |
| 56 000 | 349 000 | 100 wt % EA | Tartaric | 40 wt % | 4% | RT | Aqueous phase cloudy | 0.023 g/ | 61 400 | 339 000 |
| | | | acid | based on | | | org. phase clear | 100 g | | |
| | | | | SC | | | | | | |
| ″ | ″ | 100 wt % EA | Tartaric | 40 wt % | 4% | 40° C. | Aqueous phase cloudy | 0.028 g/ | 64 300 | 376 000 |
| | | | acid | based on | | | org. phase clear | 100 g | | |
| | | | | SC | | | | | | |
| ″ | ″ | 100 wt % EA | Tartaric | 20 wt % | 4% | 40° C. | Aqueous phase cloudy | 0.06 g/ | 76 700 | 382 000 |
| | | | acid | based on | | | org. phase clear | 100 g | | |
| | | | | SC | | | | | | |
| 40 200 | 236 000 | 80 wt % EA | Gluconic | 40 wt % | 4% | RT | White foam at | 0.002 g/ | 49 600 | 382 000 |
| | | (SC < 18%) | acid | based on | | | boundary | 100 g | | |
| | | | | SC | | | org. phase clear | | | |
| ″ | ″ | 80 wt % EA | Gluconic | 40 wt % | 4% | 40° C. | White foam at | 0.037 g/ | 41 800 | 246 000 |
| | | | acid | based on | | | boundary | 100 g | | |
| | | | | SC | | | org. phase clear | | | |
| ″ | ″ | 80 wt % EA | Na | 20 mol % | none | RT | Org. phase cloudy, | 1.2 g/100 g | 55 400 | 586 000 |
| | | | EDTA | | | | pH > 7.5 | | | |
| ″ | ″ | 80 wt % EA | Na | 20 mol % | none | 40° C. | Org. phase cloudy, | 0.89 g/100 g | 47 800 | 552 000 |
| | | | EDTA | | | | pH > 7.6 | | | |
| ″ | ″ | 100 wt % EA | Maleic | 40 wt % | 4% | 40° C. | Slowly becomes clear, | | | |
| | | | acid | based on | | | good separation | | | |
| | | | | SC | | | | | | |
| ″ | ″ | 100 wt % EA | Maleic | 40 wt % | 4% | RT | Slowly becomes clear, | | | |
| | | | acid | based on | | | good separation | | | |
| | | | | SC | | | | | | |
| ″ | ″ | 300 wt % EA | High- | none | RT | Solution | | | | |
| | | has to be | acidity | | | clear, low | | | | |
| | | very liquid | Dowex | | | flow rate; | | | | |
| | | | 50WX8- | | | only | | | | |
| | | | 200 ion | | | limited | | | | |
| | | | exchanger | | | capability, | | | | |
| | | | (column) | | | very dilute | | | | |

| | |
|---|---|
| Key | |
| EA | ethyl acetate |
| SC | solids content |
| AA | acetic anhydride |
| GPC | gel permeation chromatography |

What is claimed is:

1. A process for producing polyalkylene carbonates via polymerization of carbon dioxide with at least one epoxide of the general formula (I): 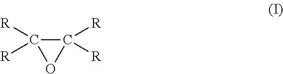
where R re mutually independently H, halogen, NO₂, CN, COOR′ or C₁₋₂₀-hydrocarbon moiety, which can have substitution, where one of the moieties R can also be OH, and where two moieties R can together form a C₃₋₅-alkylene moiety, R′ is H or C₁₋₂₀-hydrocarbon moiety, which can have substitution; on a zinc salt of C₄₋₈-alkanedicarboxylic acids as catalysts, which comprises admixing the following with the reaction mixture obtained after the reaction: a carboxylic acid or an acidic ion exchanger and a non-water-miscible organic solvent which dissolves the polyalkylene carbonate, and washing the organic phase with water, and optionally obtaining the polyalkylene carbonate from the organic phase.

2. The process according to claim 1, wherein the zinc salt of C₄₋₈-alkanedicarboxylic acids is zinc glutarate or zinc adipate.

3. The process according to claim 1, wherein the total number of carboxy and hydroxy groups in the carboxylic acid is at least 2.

4. The process according to claim 1, wherein the structure of the carboxylic acid comprises at least one hydroxy group or at least one nitrogen atom.

5. The process according to claim 1, wherein the carboxylic acid comprises at least four carbon atoms.

6. The process according to claim 1, wherein the carboxylic acid has been selected from acetic acid, citric acid, tartaric acid, gluconic acid, maleic acid, ethylenediaminetetraacetic acid (EDTA), methylglycinediacetic acid (MGDA), ascorbic acid, polycarboxylic acids, or a mixture thereof.

7. The process according to claim 1, wherein the amount of carboxylic acid is from 5 to 80% by weight, based on the polyalkylene carbonate.

8. The process according to claim 1, wherein the organic solvent is an ester.

9. The process according to claim 1, wherein the polyalkylene carbonate is reacted with a carboxylic anhydride prior to the admixture of the carboxylic acid or of the acidic ion exchanger.

10. The process according to claim 9, wherein the amount of carboxylic anhydride is from 0.5 to 25% by weight, based on the polyalkylene carbonate.

11. A process for purifying polyalkylene carbonates comprising zinc salts of C₄₋₈-alkanedicarboxylic acids, which comprises carrying out the purification steps defined in claim 1.
